(19) United States
(12) Patent Application Publication
(10) Pub. No.: US 2016/0137403 A1
(43) Pub. Date: May 19, 2016

(54) COVER FOR A BEVERAGE CAPSULE

(71) Applicant: NESTEC S.A., Vevey (CH)

(72) Inventor: Christophe Sebastien Paul Heydel, Chez-le-bart (CH)

(73) Assignee: Nestec S.A., Vevey (CH)

(21) Appl. No.: 14/898,818

(22) PCT Filed: Jun. 17, 2014
(86) PCT No.: PCT/EP14/62701

§ 371 Date: Dec. 16, 2015

(30) Foreign Application Priority Data
Jun. 25, 2013 (EP) 13173533.4

(51) Int. Cl. B65D 85/804; B65D 47/36; A47J 31/40; B29C 65/00; B32B 3/26; B32B 15/08; B32B 37/16; B32B 38/00; B65D 81/34; B32B 15/20

(52) U.S. Cl. CPC B65D 85/8046; B65D 81/34; B65D 47/36; A47J 31/407; B32B 15/20; B32B 3/266; B32B 15/08; B32B 37/16; B32B 38/0004; B29C 66/02241; B29C 66/45; B29C 66/7422; B32B 2250/02; B32B 2255/10; B32B 2311/24; B32B 2439/70; B29L 2031/7174

(57) ABSTRACT

The invention concerns a capsule (1) for the preparation of a beverage or food in a beverage or food preparation machine comprising: an enclosure (2) containing one or more beverage or food ingredients, said enclosure presenting an opening (21), a sealing cover (3) closing the opening of the enclosure.

### FIELD OF THE INVENTION

The present invention relates to a capsule for preparing and delivering a beverage with a beverage preparation device.

### BACKGROUND OF THE INVENTION

The production of beverages by means of beverage capsules usually consists in introducing a diluent, preferably water, inside a capsule comprising a beverage ingredient and evacuating the beverage issued from the contact of the diluent and the ingredient from the capsule.

There exist lots of various different manners to introduce the diluent in the capsule and to evacuate the beverage from the capsule and consequently various different capsules. Usually a capsule comprises an ingredient enclosure closed by a cover. The capsules Special-T® commercialized by Nestlé comprise a cover made of an aluminum sheet. The beverage outlet in such capsules is created by piercing said aluminum sheet. WO 2010146101 describes such a capsule wherein the beverage outlet is created by creating an opening inside the cover by pushing a piercing member against said cover. In order to identify the type of ingredient, in particular tea leaves, stored in the enclosure it would be appreciable to be able to mark the name of the ingredient on the aluminum sheet of such capsules. Yet marking by printing on an aluminum sheet presents the risk that during the preparation of a beverage with the capsule the ink enters into contact with the hot water and nay cause issues like taste change, coloration of the beverage and ink may remain in the machine. Alternatively the aluminum sheet could be marked by embossing but such a process is expansive. Then the aluminum cover could be replaced by a plastic film on which the ingredient name can be easily printed. Yet a plastic film can be resistant and cannot be pierced by any piercing member of a beverage preparation machine to create a beverage outlet in the capsule.

The object of the present invention is to propose a capsule in which the cover can simultaneously be efficiently pierced for creating a beverage outlet and be printed to provide information related to the capsule.

### SUMMARY OF THE INVENTION

According to a first aspect, the invention concerns a capsule for the preparation of a beverage or food in a beverage or food preparation machine comprising:

an enclosure containing one or more beverage or food ingredient, said enclosure presenting an opening,

a sealing cover closing the opening of the enclosure,

wherein the cover presents at least two different zones, one first zone consisting of an aluminium sheet and one second zone comprising a plastic film.

The capsule of the present invention can be configured for preparing liquid beverages like tea, coffee, milk, chocolate or more solid foods like soups, ice creams or smoothies. It comprises an enclosure for storing the beverage or food ingredients. Generally this enclosure presents a cup shaped body for holding the ingredients. The enclosure presents an opening for introducing the ingredients in the capsule at the manufacturing operation. The enclosure opening is closed by a cover that is usually sealed on the edge of the enclosure opening. The sealing can be made by heat sealing, welding or sticking.

According to the invention the cover surface presents at least two different zones, said zones differing by the nature of the cover in each zone. According to the invention the cover presents along it external surface:

at least one first zone consisting of an aluminium sheet, and

at least one second zone comprising a plastic film.

According to the preferred embodiment:

in the first zone the cover is made only of an aluminium sheet, and

in the second zone the cover comprises a plastic film, said film being positioned on the external surface of the cover.

In the present invention “external” refers to elements that are placed on the outside of the capsule whereas “internal” refers to elements that are placed on the inside of the capsule.

Preferably the second zone can be a laminate of a plastic film and an aluminium sheet.

The plastic film is positioned on the external part of the cover whereas the aluminium sheet is positioned on the internal part of the cover.

According to the preferred embodiment of the invention, the cover is a laminate of a plastic film and an aluminium sheet and the plastic film of said laminate is delaminated in the first zone.

According to the invention information can be printed on the second zone. Preferably these information relate to the external identification of the ingredients contained in the capsule. For example these information can be the name of the ingredient or a picture of the ingredient or a particular colour.

According to the preferred embodiment the second zone is a laminate of a plastic film and an aluminium sheet and the information are printed on the side of the plastic film attached to the aluminium sheet. Then the ink of the printed information does not enter into contact with the beverage preparation machine or the consumers fingers. According to this embodiment the plastic film is preferably transparent.

According to the preferred embodiment the cover surface presents one first zone and one second zone. Yet cover with several first zones of the same nature and/or several second zones of the same nature can be implemented. According to a particular mode the cover can present one second zone and at least two first zones. The invention particularly relates to a capsule comprising a wall member provided at the enclosure opening, and wherein:

said wall member is covered by the cover,

said wall member comprises at least one overflow aperture in fluid communication with the ingredient enclosure,

said wall member is provided with at least one preformed channel under the cover and designed to guide a fluid from the at least one overflow aperture to at least one recess being designed to receive dedicated opening means of a beverage preparation device, and

wherein one first zone of the cover is positioned on the cover so that the first zone is above said recess.

Preferably the cover is placed directly in contact with the wall member.

Preferably the wall member is provided with an identification member designed for being contacted from outside the capsule. In particular the identification member can comprise functional hollows and/or bulges facing the cover. According to a particular mode one first zone of the cover can be positioned above said identification member.

The invention can also concern capsule wherein the wall member is simpler—for example it is possible that it does not comprise identification member—or wherein the capsule does not comprise a wall at all.

According to a second aspect the invention concerns a system comprising a beverage preparation device and a capsule such as described hereabove for preparing a beverage by injection of a liquid into the capsule enclosure, the beverage preparation device having an opening means which is designed to interact with a first zone of the capsule cover so as to create a beverage dispensing outlet.

Preferably the opening means of the beverage preparation device comprises an opening member having a hook-like shape designed to shear and move away at least a portion of a first zone of capsule the cover. Preferably the capsule presents at least one recess is designed to receive the dedicated opening means of the beverage preparation device.

According to a particular mode the beverage preparation device can have an identification member reading means which is designed to interact with a first zone of the cover so as to identify the capsule. Preferably the wall member comprises a wall member under the cover wherein this wall is provided with an identification member designed for being contacted from outside the capsule by the identification member reading means. In particular the identification member can comprise functional hollows and/or bulges facing the cover.

According to a third aspect the invention concerns a process for manufacturing a cover of a capsule such as described hereabove comprising the steps of:

(i) providing an aluminium layer and a plastic film layer,

(ii) printing information on a face of the plastic film layer firstly and then cutting out at least one piece of the plastic film layer corresponding to the first type of zones presenting the lowest resistance to piercing,

or

cutting out at least one piece of the plastic film layer corresponding to the first type of zones presenting the lowest resistance to piercing firstly and then printing information on a face of the plastic film layer,

(iii)) laminating the printed and cut plastic film on the aluminium layer.

Preferably information are printed on the face of the plastic film layer that is laminated with the aluminium layer.

### BRIEF DESCRIPTION OF THE DRAWINGS

The characteristics and advantages of the invention will be better understood in relation to the following figures, in which:

FIG. 1 is an exploded view of a capsule according to the state of the art,

FIG. 2 illustrates a part of a beverage preparation machine configures for cooperating with a capsule of FIG. 1,

FIG. 3 is an exploded view of a capsule according to the invention,

FIGS. 4a and 4c illustrates alternative covers for the capsule of FIG. 4,

FIG. 4b is a section view of the cover of FIG. 4a according to section AA,

FIGS. 5a to 5e illustrates a process for manufacturing the cover of a capsule according to the invention.

### DETAILED DESCRIPTION OF THE DRAWINGS

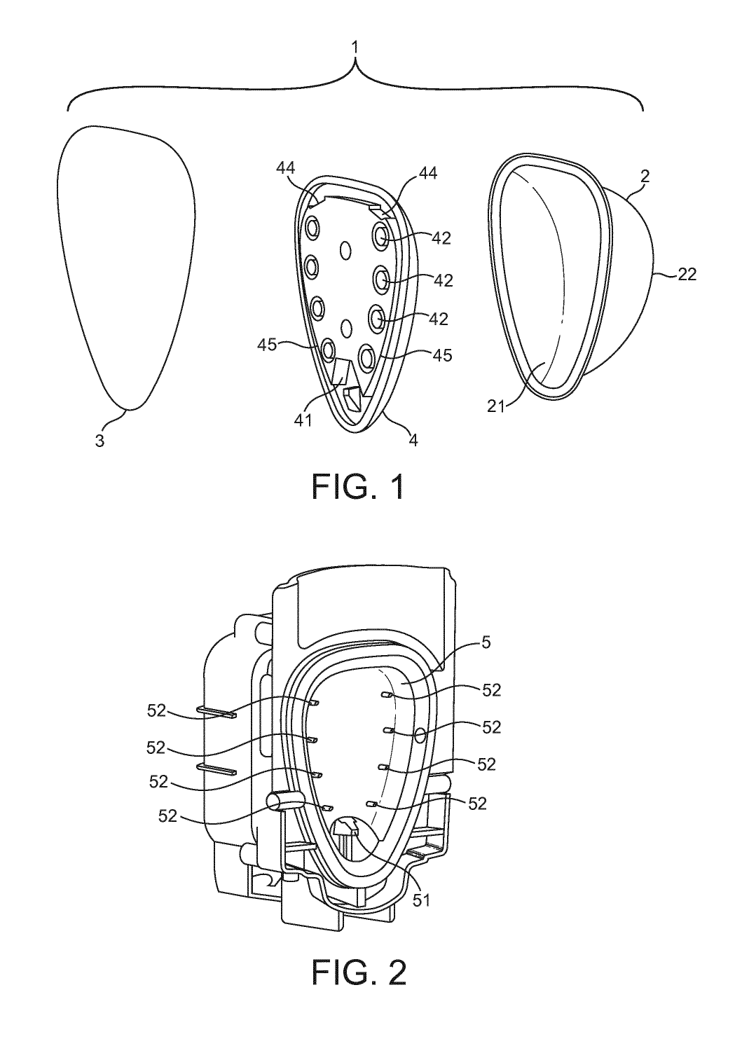

FIG. 1 illustrates the different elements of a capsule 1 according to the state of the art. The capsule 1 comprises an enclosure 2 in which beverage ingredients can be stored and presenting an opening 21 that is closed by a cover 3. In FIG. 1 the capsule also comprises a wall member 4 provided at the enclosure opening 21 and covered by the cover 3. The wall member comprises two overflow apertures 44 in fluid communication with the internal part of the ingredient enclosure. These overflow apertures 44 aim at delivering the beverage from the enclosure 2 further to the introduction of a diluent—usually water—inside the enclosure through the end 22 of the enclosure opposed to the cover. The overflow is particularly interesting for the brewing of tea leaves inside the capsule as described in WO 2007/042414. According to the invention the apertures 44 in the wall member could be designed in other part of the wall member than the upper part depending on the nature of the ingredient inside the enclosure. The wall member 4 is provided with two preformed channels 45 under the cover and designed to guide the beverage from the overflow apertures 44 to a recess 41 in the wall member 4. The wall member 4 is provided with several hollows 42 that face the cover 3. In the wall member 4 illustrated in FIG. 1 only four holes 42 are present on the right side of said member yet four other holes can be hollowed in the wall member 4 on the left side of said member. These holes or this absence of holes create an identification code on the wall member as described in WO 2008/090122 more precisely.

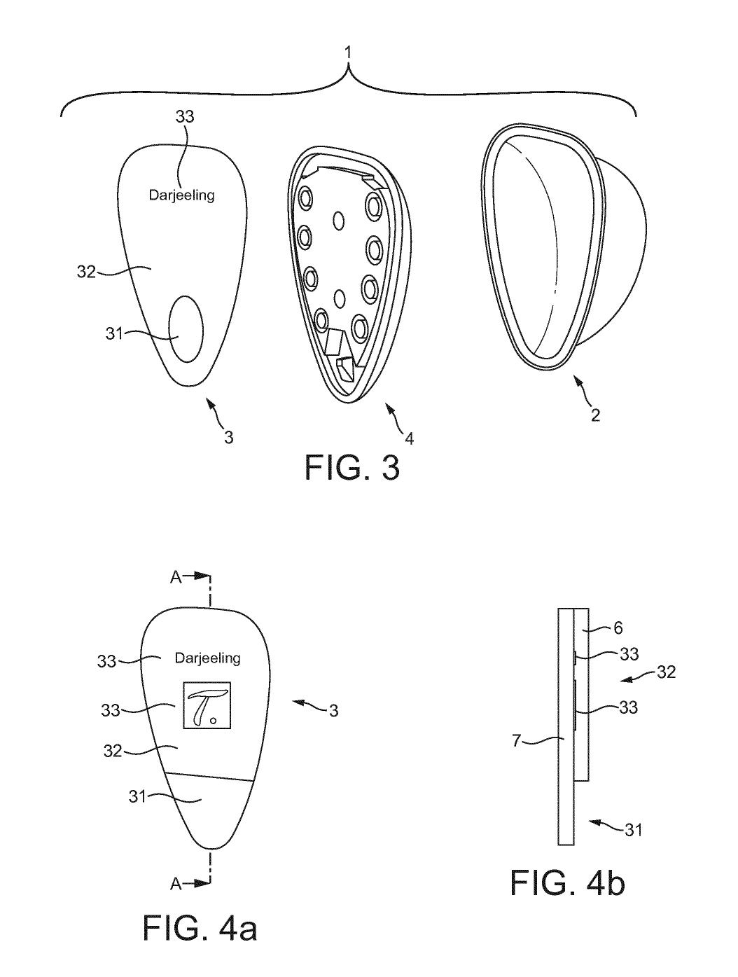

FIG. 2 illustrates the part of the beverage preparation machine designed for cooperating with the capsule 1 of FIG. 1 when the capsule is introduced in the machine and the beverage preparation is launched. Said part of the machine comprises a capsule engagement wall 5 that enters into contact with the capsule cover 3 as follows. The capsule is introduced in the beverage preparation machine and pressed against the capsule engagement wall 5. The capsule engagement wall 5 comprises an opening member 51 designed for cooperating with the recess 41 in the wall member of the capsule so that the cover is torn by the introduction of the opening member in the recess. This effect can be optimally obtained when the cover is made in a material like an aluminum sheet. This effect is described in WO 2010/146101 more precisely. The capsule engagement wall 5 comprises eight pins 52 too. These pins 52 are designed for cooperating with the holes 42 in the wall member of the capsule or with the absence of such hole in the wall member. The pins 52 can sense the presence or absence of holes through the cover without piercing it. They can also pierce it depending on the nature of the cover or the fineness of the pins.

Such a system of capsule and machine corresponds for example to the system commercialised under the trademark Special-T® by Nestlé. In this system the whole cover 3 is made of the same aluminium sheet.

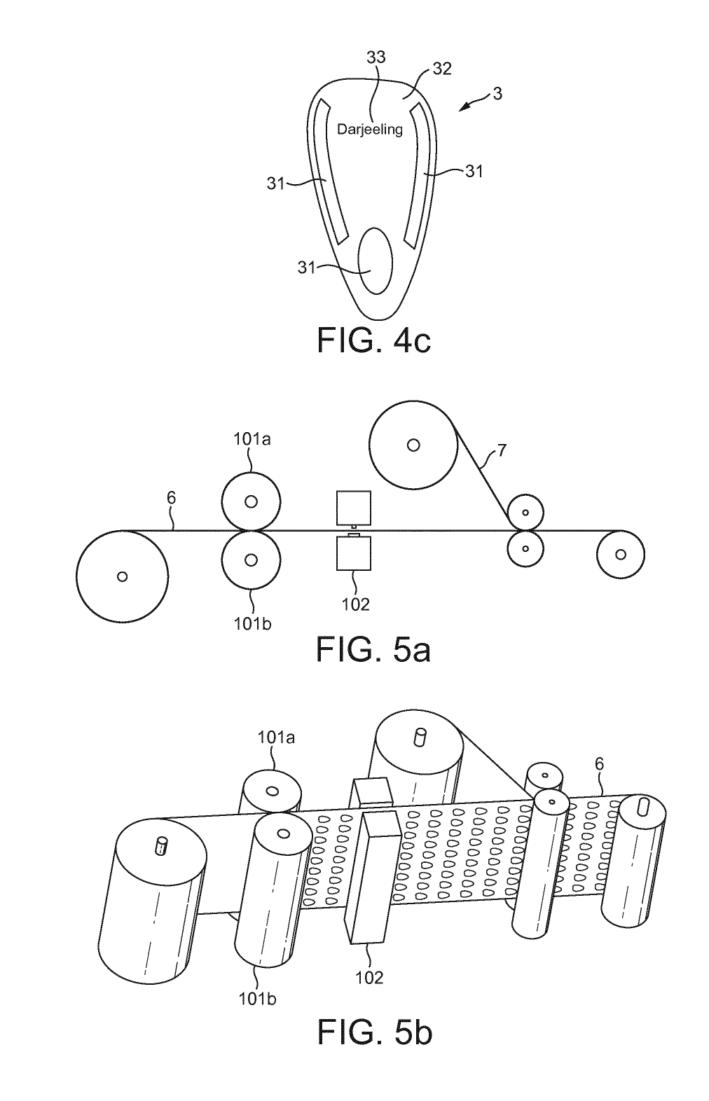

FIG. 3 is an exploded view of a capsule 1 according to the invention. The capsule presents the same components as the capsule of the prior art according to FIG. 1 except that the cover 3 is not made of a uniform sheet of aluminium. In FIG. 3 the cover comprises a first zone 31 made of an aluminium sheet only; this first zone 31 presents a low resistance to piercing as in the prior and can be torn by tearing the first zone 31 when the opening means 51 of the machine enters in the recess 41 of the wall member 4 due to the pressure of the capsule against the capsule engagement wall 5. The second zone 32 of the cover is made of a plastic film. This film can be printed with a name (“Darjeeling”) 33 of the ingredient in the capsule. In FIG. 3 the first zone 31 extends on the part of the cover surface corresponding to the recess 41 in the wall member.

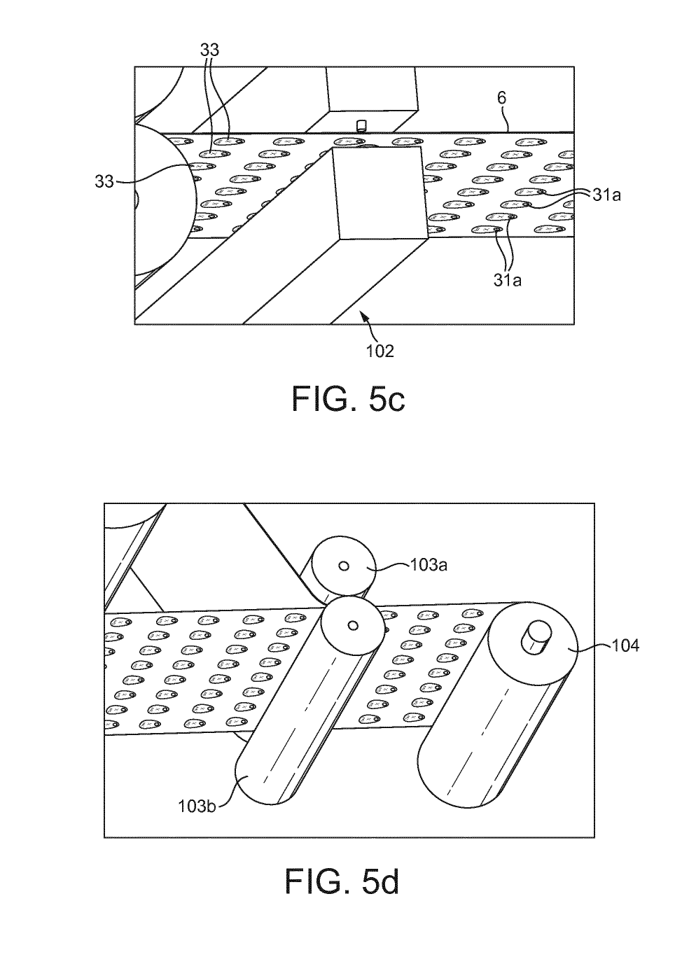

FIG. 4a illustrates an alternative wherein the first zone 31 can be bigger than the simple surface facing the recess 41 of the wall member and corresponds to the whole lower part of the cover 3. The definition of the size and the shape of the first zone 31 can depend on the more efficient way to manufacture such a cover. In FIG. 4a, the cover 3 can also support in its second zone 32 printed information about the trademark of the capsule or any other type of information.

FIG. 4b is a section of the cover of FIG. 4a: it makes apparent that the lower part of the cover—that is the first zone 31—is made of only an aluminium sheet 7 whereas the rest of the cover—that is the second zone 32—is a laminate of the aluminium sheet 7 and a plastic film 6 with the plastic film 6 positioned on external surface of the cover. The aluminium sheet 7 is the same for the two zones. Such a cover is issued from the lamination of a plastic film 6 on an aluminium sheet 7, a part of the plastic having been hollowed out. Information 33 are printed on the plastic film 6 and are recovered by the aluminium sheet.

FIG. 4c illustrates an alternative wherein the cover 3 comprises three first zones 31 one facing the recess 41 of the wall member and the others facing the part of the wall member 4 presenting holes or no holes for identifying the capsule. Depending on the type of pins 52 of the machine and the force applied by the machine in the cover during beverage preparation the identification step can be improved by reducing the resistance to piercing of the cover in these both areas.

The manufacturing of a cover presenting at least one first zone made of an aluminium sheet and the second zone is made of a printable plastic film can consist in using a laminate of a plastic film and an aluminium sheet and removing the plastic film from said laminate to create said at least one first zone.

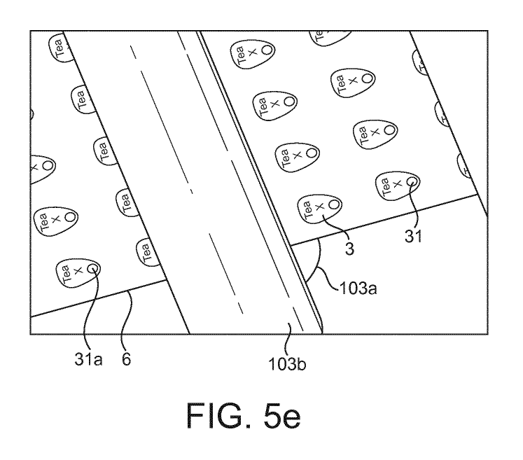

FIGS. 5a to 5e illustrates a process for manufacturing the cover 3. FIGS. 5a and 5b are side view and bottom view of the manufacturing line respectively. The process uses an aluminium layer 7 and a plastic film layer 6. The aluminium layer 7 and the plastic film layer 6 are in the form of a continuous web, provided as rolls of material of a particular width. This is particularly advantageous in that techniques for the handling of such rolls, and the design of machines to do so, are well known from such arts as printing and paper-making. However, the method of the present invention may be easily adapted for use with substrates in other forms, for instance sheets, plates or the like.

The plastic film layer is passed to the printing rollers 101a, 101b for printing information on the plastic film layer for each capsule cover 3 to be prepared from the plastic film.

Then the printed plastic film layer 6 is brought to the cutting apparatus 102 for cutting out the zone corresponding to the first zone in the covers as illustrated in FIG. 5c. The cutting apparatus is configured for cutting out in each portion of plastic film defined to form a cover 3 a part of the plastic film corresponding to the first zone 31 of the cover. The cutting apparatus can implement an array of cutting lasers or a die cutting apparatus, for instance in the form of a roller or press disposed against the plastic film 6.

From the cutting apparatus 102 the printed and cut out plastic film layer 6 is joined to the aluminium layer 7 through the collimating rollers 103a and 103b as illustrated in FIGS. 5d and 5e. The collimating rollers 103a and 103b press the printed and cut out plastic film layer 6 and the aluminium layer 7 together, bringing them in contact with each other. As the both layers are pulled through the collimating rollers, the pressure applied by the collimating rollers creates a tension on the layers, eliminating air bubbles, wrinkles, and other defects. The layers are thus brought into correct position relative to each other. The collimating rollers further serve to attach the both layers. The plastic film layer 6 or the aluminium layer comprises a heat or pressure sensitive adhesive on the face put into contact with the other by the collimating rollers. Due to the pressure applied by the rollers or the heat of these rollers the both layers are attached one to the other. At the output of the collimating rollers 103a, 103b a film of covers 3 is obtained. Each cover presents a zone printed with information 33 and a first zone made of only an aluminium sheet 31. The attached layers are then wound about the take-up roller 104.

In the above manufacturing process the printing operation is realised on the side of the plastic film layer 6 that is going to be attached and recovered by the aluminium sheet layer 7 during the collimating step. Consequently the ink printed area is covered by aluminium and there is no risk that this area may contact the internal parts of the beverage preparation machine. Then the plastic film layer is preferably transparent. Otherwise the printed information are not visible.

The present invention provides capsules presenting covers that can be printed and remains easily pierceable.

The present invention proposes a simple solution for producing a capsule cover presenting zones of different natures.

1. Capsule for the preparation of a beverage or food in a beverage or food preparation machine comprising:
an enclosure containing one or more beverage or food ingredients, the enclosure presenting an opening;
a sealing cover closing the opening of the enclosure; and
the cover comprises at least two different zones, one first zone comprising an aluminium sheet and one second zone comprising a plastic film.

2. Capsule according to claim 1 wherein the second zone is a laminate of a plastic film and an aluminium sheet.

3. Capsule according to claim 1 wherein the cover is a laminate of a plastic film and an aluminium sheet and the plastic film of the laminate is delaminated in the first zone.

4. Capsule according to claim 1 wherein information is printed on the second zone.

5. Capsule according to claim 1 wherein the second zone is a laminate of a plastic film and an aluminium sheet and the information are printed on the side of the plastic film attached to the aluminium sheet.

6. Capsule according to claim 1 wherein the plastic film is transparent.

7. Capsule according to claim 1 wherein the cover comprises one second zone and at least two first zones.

8. Capsule according to claim 1 wherein the capsule comprises a wall member provided at the enclosure opening, wherein:
the well member is covered by/under the cover,
the wall member comprising at least one overflow aperture in fluid communication with the ingredient enclosure,
the wall member is provided with at least one preformed channel under the cover and designed to guide a fluid from the at least one overflow aperture to at least one recess being designed to receive dedicated opening means of a beverage preparation device, and
one first zone of the cover is positioned above the recess.

9. Capsule according to claim 8 wherein the wall member is provided with an identification member designed for being contacted from outside.

10. Capsule according to claim 9 wherein the identification member comprises functional hollows and/or bulges facing the cover.

11. Capsule according to claim 9 wherein one first zone of the cover is positioned above the identification member.

12. A system comprising a beverage preparation device and a capsule for the preparation of a beverage or food comprising:
a capsule comprising an enclosure containing one or more beverage or food ingredients, the enclosure presenting an opening; a sealing cover closing the opening of the enclosure; and the cover comprises at least two different zones, one first zone comprising an aluminium sheet and one second zone comprising a plastic film for preparing a beverage by injection of a liquid into the capsule enclosure;
the beverage preparation device having an opening member which is designed to interact with the first zone of the cover so as to create a beverage dispensing outlet.

13. A system according to claim 12 wherein the opening member comprises a member having a hook-like shape designed to shear and move away at least a portion of the first zone of cover.

14. A system according to claim 12 wherein the beverage preparation device has an identification member reader which is designed to interact with one first zone of the cover to pierce the cover so as to identify the capsule.

15. Process for manufacturing a cover of a capsule comprising the steps of:
(i) providing an aluminium layer and a plastic film layer,
(ii) printing information on a face of the plastic film layer and then cutting out at least one piece of the plastic film layer corresponding to the first type of zones presenting the lowest resistance to piercing, and
(iii) laminating the cut and printed plastic film layer on the aluminium layer.

16. Process according to claim 15 wherein the printed plastic film layer is laminated to the aluminium layer through its printed face.

17. Process for manufacturing a cover of a capsule comprising the steps of:
(i) providing an aluminium layer and a plastic film layer,
(ii) cutting out at least one piece of the plastic film layer corresponding to the first type of zones presenting the lowest resistance to piercing and then printing information on a face of the plastic film layer, and
(iii) laminating the cut and printed plastic film layer on the aluminium layer.
